(19) United States
(12) Patent Application Publication
(10) Pub. No.: US 2025/0067609 A1
(43) Pub. Date: Feb. 27, 2025

(54) DETERMINING SEATBELT POSITION WITH PRESSURE SENSING GARMENT

(71) Applicant: XSENSOR Technology Corporation, Calgary (CA)

(72) Inventor: Terence Russell, Calgary (CA)

(21) Appl. No.: 18/814,377

(22) Filed: Aug. 23, 2024

Related U.S. Application Data
(60) Provisional application No. 63/578,978, filed on Aug. 25, 2023.

(51) Int. Cl. G01L 5/00; G01L 1/14; G01M 17/007

(52) U.S. Cl. CPC G01L 5/0052; G01L 1/146; G01M 17/0078

(57) ABSTRACT

A system determines the position of a seatbelt in a crash test using a pressure sensing garment affixed to a crash test dummy. The pressure sensing garment is a surface or material configured to measure pressure applied to the crash test dummy during a crash test. The pressure sensing garment measures pressure applied to the crash test dummy using a capacitive sensor grid. The system determines the position of the seatbelt based on the pressure data from the pressure sensing garment and may apply various algorithms to automatically determine the angle and centerline of the seatbelt based on the pressure data.

### CROSS-REFERENCE TO RELATED APPLICATIONS

This application claims the benefit of U.S. Provisional Patent Application No. 63/578,978 filed Aug. 25, 2023, which is incorporated by reference in its entirety.

### TECHNICAL FIELD

The present disclosure generally relates to determining a position of a seatbelt during a crash test, in particular to determining a position of a seatbelt during a crash test using a pressure sensing garment.

### BACKGROUND

Crash tests are used to evaluate a vehicle's ability to withstand a collision and to assess injuries that the collision may cause to human occupants of the vehicle. Crash tests are typically performed with a crash test dummy strapped into a vehicle by a seatbelt. A collision is caused with the vehicle, and damage to the vehicle and/or crash test dummy is assessed. Engineers may infer information about a collision based on how objects in the vehicle interact with the crash test dummies. For example, engineers may evaluate where air bags hit the crash test dummies or at what point during a collision did airbags deploy. Engineers may also evaluate the behavior of the seatbelt restraining the crash test dummy, for example if the seatbelt stayed on, twisted, or buckled during the collision. Part of an engineer's analysis of seatbelt behavior may include determining a seatbelt contact patch, an area where a seatbelt contacts the chest of the crash test dummy. However, determining a seatbelt contact patch is a difficult and often manual process involving expert analysis. Additionally, determining a seatbelt contact patch can be subjective, such that different engineers determine different seatbelt contact patches.

### SUMMARY

A system determines the position of a seatbelt in a crash test using a pressure sensing garment affixed to a crash test dummy. The pressure sensing garment is a surface or material configured to measure pressure applied to the crash test dummy during a crash test. The pressure sensing garment measures pressure applied to the crash test dummy using a capacitive sensor grid. The system determines the position of the seatbelt based on the pressure data from the pressure sensing garment and may apply various algorithms to automatically determine the angle and centerline of the seatbelt based on the pressure data. In measuring pressure applied by a seatbelt with a pressure sensing garment, the system significantly improves the process for determining the position of the seatbelt. The system provides an objective way to determine seatbelt position and removes the need for manual determination of a seatbelt's centerline.

### BRIEF DESCRIPTION OF THE DRAWINGS

Figure (FIG. 1A is a block diagram illustrating an example system environment, in accordance with some embodiments.

FIG. 1B shows an example system environment of a crash test, in accordance with some embodiments.

FIG. 2 is a block diagram illustrating an example computing server, in accordance with some embodiments.

FIGS. 3A and 3B show an example pressure sensing garment affixed to the body of a crash test dummy, in accordance with some embodiments.

FIG. 4 is a conceptual diagram illustrating a top view of an example capacitive sensor grid, in accordance with some embodiments.

FIG. 5 shows an example grid of pressure measurements, in accordance with some embodiments.

FIG. 6 is a flowchart depicting an example process for determining the centerline of a seatbelt, in accordance with some embodiments.

FIG. 7 is an example structure of a machine learning model, according to some embodiments.

FIG. 8 is a block diagram illustrating components of example computing machines, according to some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments described herein relate to a system for determining the position of a seatbelt relative to pressure sensing data from a pressure sensing garment affixed to a crash test dummy, the pressure sensing data taken during a collision of a vehicle during a crash test.

Crash tests are a type of testing used to evaluate a vehicle's ability to withstand a collision and to assess injuries that the collision may cause to human occupants of the vehicle. A crash test involves simulating an accident with the vehicle. For example, a frontal crash test simulates an accident where the vehicle is struck head-on by another vehicle of the same size. A side barrier crash test simulates an accident where the vehicle is struck on the driver's side. A crash test setup includes the vehicle being evaluated, an opposing force (e.g., another vehicle or obstacle involved in the collision), and one or more crash test dummies. A crash test dummy is a model of a human that is placed inside the vehicle to represent a driver or a passenger. During a crash test, a crash test dummy is secured with a seatbelt inside the vehicle. Crash test dummies include sensors like accelerometers, load sensors, and motion sensors that record data about the collision. Crash test dummies come in different sizes to represent humans of different ages and genders.

In some embodiments, a pressure sensing garment is affixed to a crash test dummy. The pressure sensing garment is a surface or material configured to measure pressure applied to the body of the crash test dummy during a collision. The pressure sensing garment may measure pressure applied to the front or back of the crash test dummy. In some embodiments, the pressure sensing garment may be a garment worn on the body of a crash test dummy, for example as a vest or shirt. The pressure sensing garment may also be a surface or material affixed to the crash test dummy, such as a flexible panel applied to the chest of the crash test dummy. The pressure sensing garment includes a thin and flexible capacitive sensor grid. The sensor grid includes two types of electrodes: columns, where a sinusoidal electrical signal may be injected; and rows, where an attenuated sinusoidal signal may be detected. The electrodes are separated by a compressible, permeable dielectric material. When the material is compressed, for example during a crash test collision, the injected electrical signal is attenuated as it passes through the dielectric. The attenuation is measured by sensor electronics. By arranging these electrode pairs on a sensor mat, a matrix of pressure values can be captured. Alternative or additional sensing technologies that may be used in the pressure sensing garment include piezoelectric sensors, accelerometers, electrodes, and resistive pressure sensors. In some embodiments, the signals from these sensors can supplement the information provided by the matrix of pressure values to provide richer information for use in a seatbelt detection system.

The pressure sensing garment may detect pressure applied to a seatbelt contact patch over the course of a collision. The seatbelt contact patch is an area where a seatbelt contacts the chest of the crash test dummy. Pressure applied to a seatbelt contact patch may help engineers better understand the impact of the collision on a human body. For example, high pressure in the seatbelt contact patch may cause injuries to a human body. The pressure sensing garment may detect pressure that comes from outside of the seatbelt contact patch, for example pressure from an airbag hitting the front of the crash test or from the crash test dummy hitting the dashboard of the vehicle. The difference between the pressure inside and outside of the seatbelt contact patch may provide further insight into the crash, for example if the seatbelt failed to prevent a collision between the crash test dummy and the dashboard. This pressure data may also be used to determine the displacement of the seatbelt over the course of the crash. This data may provide engineers insight as to whether the seatbelt moved or came off during the collision.

### Example System Environments

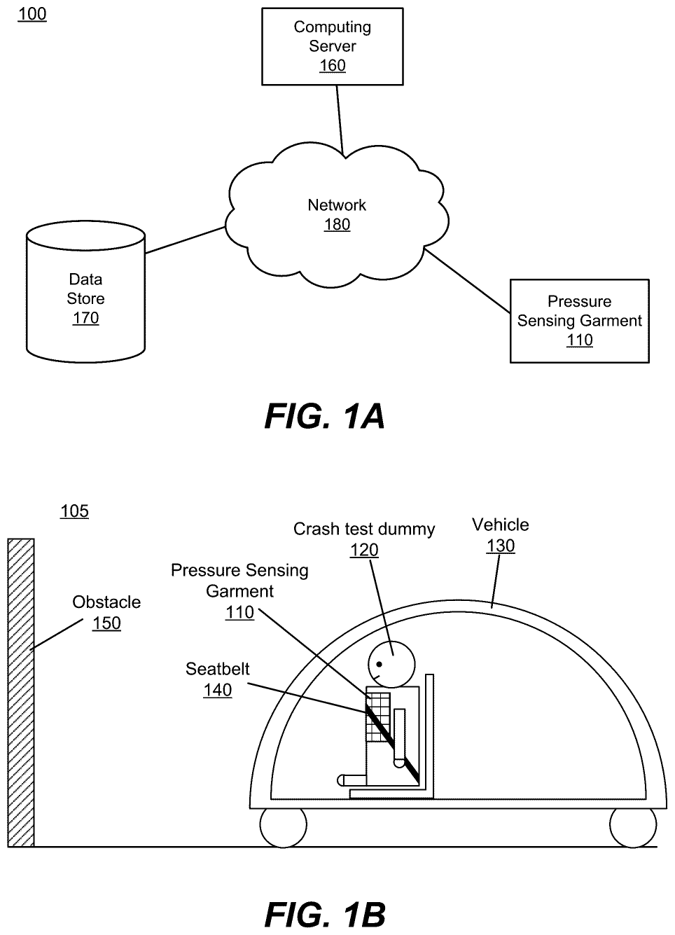

Referring now to Figure (FIG. 1A, shown is a block diagram illustrating an embodiment of an example system environment 100, in accordance with some embodiments. By way of example, the system environment 100 includes a pressure sensing garment 110, a computing server 160, a data store 170, and network 180. In various embodiments, the system environment 100 may include fewer or additional components. The system environment 100 also may include different components. Also, while some of the components in the system environment 100 may sometimes be described in a singular form, the system environment 100 may include one or more of each of the components.

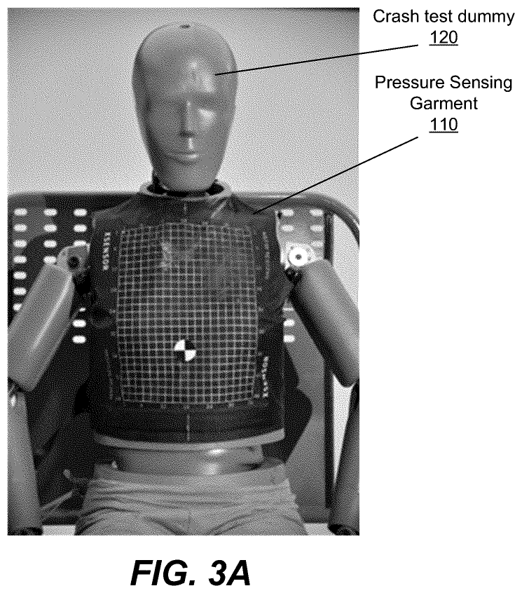

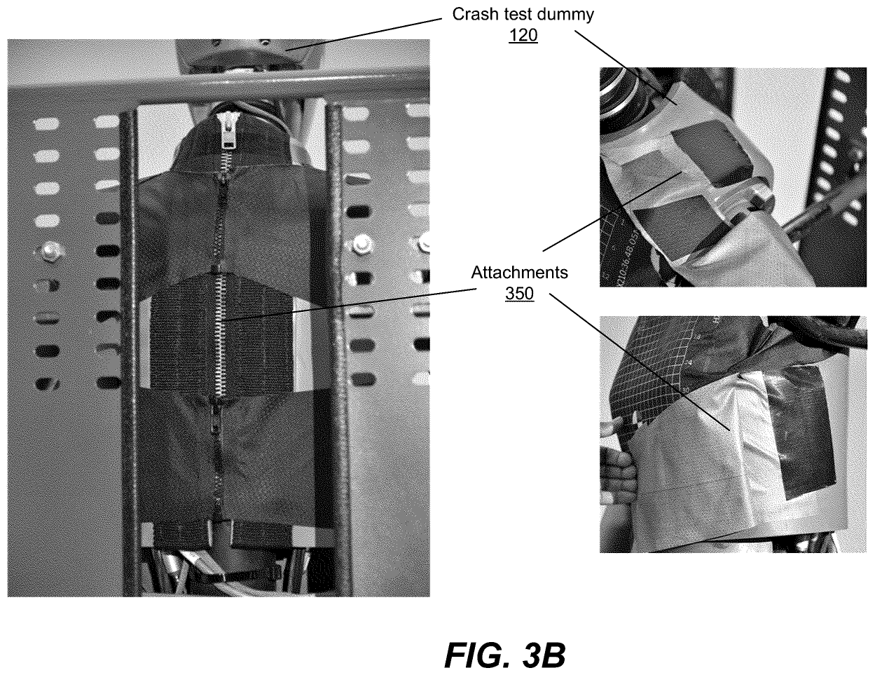

The pressure sensing garment 110 is a surface or material configured to measure pressure applied to the body of the crash test dummy during a collision. The pressure sensing garment 110 may be a garment worn on the body of a crash test dummy, for example as a vest or shirt. The pressure sensing garment may also be a surface or material affixed to the crash test dummy, such as a flexible panel applied to the chest of the crash test dummy. FIG. 3A shows an example pressure sensing garment 110 affixed to the body of a crash test dummy 120. The pressure sensing garment in FIG. 3A is a panel that is attached to the front, chest region of the crash test dummy. FIG. 3B shows examples of how the pressure sensing garment 110 can be attached to the crash test dummy 120. For example, the pressure sensing garment 110 may be attached to the crash test dummy 120 using sticky attachments 350, as shown in the right two images, or using a zipper attachment 350, as shown in the left image.

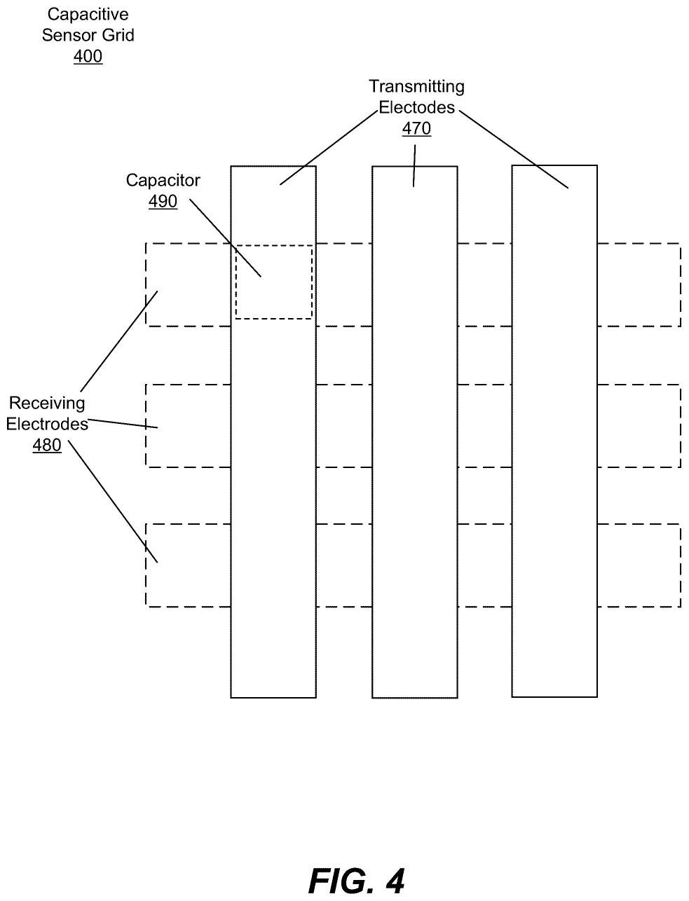

During a collision, pressure may be applied to the front of the crash test dummy 120. The pressure sensing garment 110 measures pressure applied to the crash test dummy 120 using a capacitive sensor grid embedded in the pressure sensing garment 110. The capacitive sensor grid may be thin and flexible, such that it may be shaped to lay against a non-flat surface, like the chest of the crash test dummy 120. FIG. 4 is a conceptual diagram illustrating a top view of a capacitive sensor grid 400. The capacitive sensor grid 400 includes two types of electrodes: columns, where a sinusoidal electrical signal may be injected; and rows, where an attenuated sinusoidal signal may be detected. The column electrodes and row electrodes may be arranged in longitudinal and lateral directions, as shown by transmitting electrodes 470 and receiving electrodes 480 in FIG. 4, though this is only an example configuration. The transmitting electrodes 470 and the receiving electrodes 480 may be identical or substantially similar, except the receiving electrodes 480 are flipped and rotated 90 degrees from the transmitting electrodes 470. In various embodiments, the transmitting electrodes 470 and receiving electrodes 480 may be arranged relative to each other in any suitable manners and directions, perpendicular or not, regularly or not, symmetrical or not, straight or curved, branched or unbranched, evenly spaced or not, aligned parallelly or not, and with same orientation or not.

The transmitting electrodes 470 and receiving electrodes 480 are formed from conductive materials such as metallic conductive strips or wires. Each electrode may be individually encapsulated by a thermoplastic material. The thermoplastic material may be formed from flexible, insulating, and dielectric materials that are preferably as thin as possible. For example, in some embodiment, the thermoplastic material may be an elastomer such as urethane. Other thermoplastic elastomers (TPE) or thermoplastic polyurethanes (TPU) may also be possible. The thermoplastic material provides insulation and protection to each electrode to prevent short circuit or cross talk of the electrodes. The thermoplastic material also surrounds the electrodes and serves as a bonding medium to secure the electrodes to materials of the pressure sensing garment 110, such as fabric of the garment. Thermoplastic material can be heat activated to be heat laminated and thermally bonded to materials of the pressure sensing garment 110.

The transmitting electrodes 470 and receiving electrodes 480 cross over each other to form intersections that have a dielectric layer sandwiched between the two electrodes, thereby forming a capacitor 490 at each intersection. Each capacitor 490 is a sensing point of the capacitive sensor grid 400. The network of intersections form a matrix of sensing points that can generate different measures of capacitance across different areas of the weight support device. In some embodiments, the capacitance may be proportional to or otherwise correlated with the force and pressure exerted on the pressure sensing garment 110. When the pressure sensing garment 110 is compressed, for example by a seatbelt during a collision, the distance between the transmitting electrodes 470 and the receiving electrodes 480 is reduced. As a result, the injected electrical signal is attenuated as it passes through the dielectric. This attenuation may be measured by sensor electronics and correlated to the amount of pressure applied to the pressure sensing garment 110. Alternative or additional sensing technologies that may be used in the pressure sensing garment include piezoelectric sensors, accelerometers, electrodes, fiber-optic pressure sensors, and resistive pressure sensors.

The pressure sensing garment 110 may generate sensor signals and be in communication with a computer, such as the computing server 160, to collect pressure data. The pressure sensing garment 110 may measure the pressure exerted on the crash test dummy using a capacitive sensor grid to generate a matrix of pressure readings.

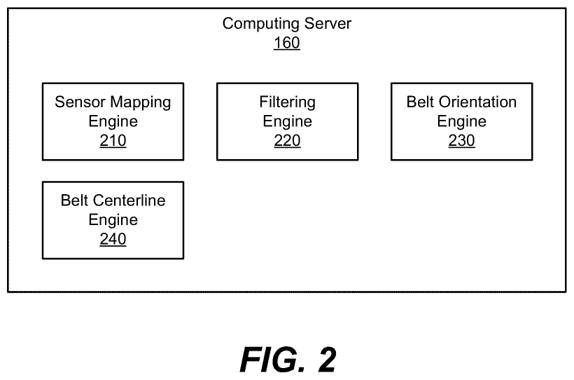

The computing server 160 may be a remote server that is used to analyze pressure data collected from the pressure sensing garment 110 to determine position or displacement of the seatbelt on the crash test dummy. The computing server 160 may also generate the sensor signals for the conductive sensor of the pressure sensing garment 110. The computing server 160 may take different forms. In one embodiment, the computing server 160 may be a server computer that executes code instructions to cause one or more processors to perform various processes described herein. In another case, the computing server 160 may be a pool of computing devices that may be located at the same geographical location (e.g., in a server room) or be distributed geographically (e.g., cloud computing, distributed computing, or in a virtual server network). The computing server 160 may also include one or more virtualization instances such as a container, a virtual machine, a virtual private server, a virtual kernel, or another suitable virtualization instance. The engines of the computing server 160 are described with respect to FIG. 2.

The data store 170 includes one or more storage units such as memory that takes the form of non-transitory and non-volatile computer storage medium to store various data that may be uploaded by the pressure sensing garment 110 or other components of the system environment 100. The computer-readable storage medium is a medium that does not include a transitory medium such as a propagating signal or a carrier wave. The data store 170 may store sensor data (e.g., pressure data) captured by the pressure sensing garment 110 and also analysis results generated by the computing server 160, such as the determined seatbelt contact patch or seatbelt displacement. The data store 170 may take various forms. In one embodiment, the data store 170 communicates with other components by the network 180. This type of data store 170 may be referred to as a cloud storage server. Example cloud storage service providers may include AWS, AZURE STORAGE, GOOGLE CLOUD STORAGE, etc. In another embodiment, instead of a cloud storage server, the data store 170 is a storage device that is controlled and connected to the computing server 160. For example, the data store 170 may take the form of memory (e.g., hard drives, flash memories, discs, ROMs, etc.) used by the computing server 160 such as storage devices in a storage server room that is operated by the computing server 160.

The network 180 provide connections to the components of the system environment 100 through one or more sub-networks, which may include any combination of the local area and/or wide area networks, using both wired and/or wireless communication systems. In one embodiment, the network 180 use standard communications technologies and/or protocols. For example, a network 180 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 180 may be represented using any suitable format, such as hypertext markup language (HTML), extensible markup language (XML), JavaScript object notation (JSON), structured query language (SQL). In some embodiments, all or some of the communication links of a network 180 may be encrypted using any suitable technique or techniques such as secure sockets layer (SSL), transport layer security (TLS), virtual private networks (VPNs), Internet Protocol security (IPsec), etc. The network 180 also include links and packet switching networks such as the Internet.

FIG. 1B shows an example system environment of a crash test. The system environment 105 includes the pressure sensing garment 110, a crash test dummy 120, a vehicle 130, a seatbelt 140, and an obstacle 150. The crash test setup includes the vehicle 130, an obstacle 150, and a crash test dummy 120. The vehicle 130 may be a car, a truck, or any other type of vehicle. The obstacle 150 may be a wall, another vehicle, or any other type of obstacle. The obstacle 150 may be stationary or moving. The crash test dummy 120 is a model of a human that is placed inside the vehicle 130 to represent a driver or a passenger. The crash test setup may include one or more crash test dummies 120 to represent one or more humans in the vehicle. The crash test dummy 120 is secured with a seatbelt 140 inside the vehicle 130. The pressure sensing garment 110 is affixed to the crash test dummy 120 to measure pressure applied to the chest of the crash test dummy.

Referring now to FIG. 2, the computing server 160 may take the form of a combination of hardware and software and may include a sensor mapping engine 210, a filtering engine 220, a belt orientation engine 230, and a belt centerline engine 240. The computing server 160 detects a position of a seatbelt based on pressure data collected by the pressure sensing garment 110. In some embodiments, and as described below, the computing server 160 may determine the angle and centerline of the seatbelt. The computing server 160 may use the detected position of the seatbelt in analysis of the crash test.

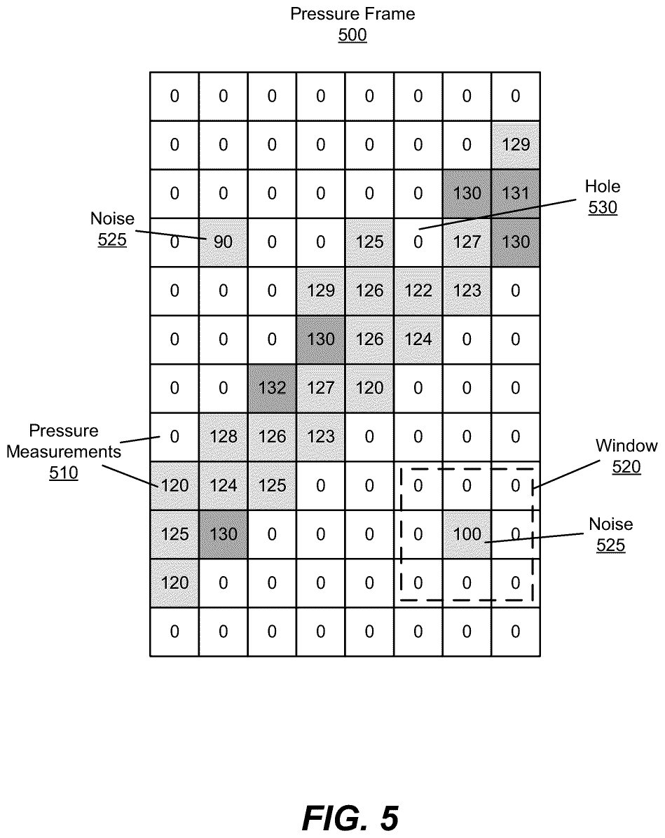

The sensor mapping engine 210 may receive and organize pressure data from the pressure sensing garment 110. The sensor mapping engine 210 may organize the pressure data into a grid of measurements representative of the sensor array. FIG. 5 shows an example grid of pressure measurements, referred to as a “pressure frame.” A pressure frame refers to a grid of measurements that corresponds to a particular point in time during a crash test. For example, pressure frame 500 may correspond to a time shortly after a collision, when the seatbelt made contact with the chest of the crash test dummy. Each pressure measurement 510 of the pressure frame 500, a “cell” of the pressure frame 500, corresponds to a point in the pressure sensing garment 110 where the electrodes of the capacitive sensor overlap to form a capacitor. Areas of high pressure (e.g., areas that correspond to pressure measurements above a threshold pressure measurement value) are shown in a dark shade compared to areas of low pressure (e.g., areas that correspond to pressure measurements below a threshold pressure measurement value). In this example, an area of higher pressure (e.g., shaded region) is shown across the body of the crash test dummy, from the bottom left to the upper right of the pressure frame 500. A grid with this type of pattern (e.g., high pressure in a diagonal across the pressure sensing garment) may correspond to pressure applied to the pressure sensing garment 110 by a seatbelt.

The sensor mapping engine 110 may receive, from the pressure sensing garment 110, a set of parameters associated with the pressure frame. For example, the sensor mapping engine 110 may receive the time of the pressure frame, the distance between measurements in the pressure frame, the width of the seatbelt, or other information about the crash test. In some embodiments, the sensor mapping engine 110 may receive parameters from external sources, such as parameters input by a facilitator of the crash test. The sensor mapping engine 210 may also calculate a number of parameters from the grid of pressure measurements. For example, the sensor mapping engine 210 may determine one or more areas of high shear (e.g., another pressure-related parameter). In some embodiments, the sensor mapping engine 210 determines an area of high shear based on pressure gradients between cells in the pressure frame. For example, a gradient between adjacent cells that is greater than a threshold gradient value corresponds to an area with high shear. Areas of high shear may indicate the edge of the seatbelt contact patch. Using FIG. 5 as an example, an area of high shear may be where the pressure measurements 510 turn from white (e.g., 0) to gray (e.g., greater than 100).

The filtering engine 220 applies one or more filters to the frame of pressure data to eliminate pressure data that comes from outside the seatbelt contact patch. Pressure data that comes from outside the seatbelt contact patch tends to be lower pressure than the pressure of the seatbelt contact patch itself. The filtering engine 220 applies a low pressure filter to remove areas of low pressure from the frame, thus removing noise from the frame. The filtering engine 220 may apply the low pressure filter to a window of the pressure frame. For example, the filtering engine 220 may apply the low pressure filter to a window of the frame that is 3 by 3 grid cells in area. The filtering engine 220 may calculate the average pressure of the window and compare it to the average pressure of the entire frame. If the average pressure of the window is below half of the average pressure of the entire frame, the filtering engine 220 determines that the window contains a region of low pressure. The filtering engine sets the value of the center grid cell to zero, effectively filtering the grid cell from the pressure frame. Returning to FIG. 5, for example, the filtering engine 220 may determine that the average pressure of the entire pressure frame 500 is approximately 35 and that the average pressure of window 520 is approximately 11. Since the average pressure of the window 520 is less than half of the average pressure of the pressure frame 500 (e.g., 11 is lower than 17.5), the filtering engine 220 changes the value of the center grid cell from 100 to zero, effectively filtering out the noise 525 from the pressure frame 500. The filtering engine 220 may slide the window across the entire pressure frame and repeat the calculations. The filtering engine 220 may use a window of any size and may filter according to any criteria (e.g., not just when the average pressure of the window is less than half the average pressure of the entire frame).

The filtering engine 220 may apply a filter to remove areas of pressure that are disconnected from the seatbelt contact patch. The filtering engine 220 may identify cells in the pressure frame that are surrounded by cells with zero pressure. The filtering engine 220 may set the value of the identified cells to zero, effectively filtering the cells from the pressure frame. For example, the filtering engine 220 may determine that the noise 525 in FIG. 5 are surrounded by cells with zero pressure and set the values of those cells to zero.

The filtering engine 220 may apply a filter to fill in holes of the seatbelt contact patch. A hole is a cell in the pressure frame that should correspond to the seatbelt contact patch, but has a pressure value of zero. Holes may be created by buckling in the seatbelt that occurs during a crash test. The filtering engine 220 may identify holes by identifying cells in the pressure frame that have zero pressure, but are surrounded by cells with non-zero pressure. In some embodiments, the filtering engine 220 may ensure that the number of surrounding non-zero pressure cells is greater than a threshold to avoid confusing a zero-pressure cell near the edge of the seatbelt contact patch with a hole in the seatbelt contact patch. The filtering engine 220 computes the average pressure of the surrounding cells with non-zero pressure values and sets the value of the hole to the computed average. For example, FIG. 5 shows a hole 530. The filtering engine 220 may identify the hole 530 as a cell with zero pressure surrounded by seven cells with non-zero pressure. The filtering engine 220 may determine that seven is greater than a threshold number of surrounding non-zero pressure cells (e.g., greater than a threshold of six cells). The filtering engine 220 may compute the average pressure of the non-zero pressure cells surrounding the hole 530 as approximately 126 and set the pressure value of the hole 530 to 126, effectively “filling” the hole 530.

The belt orientation engine 230 determines the orientation of the seatbelt contact patch. The belt orientation engine 230 computes the center of pressure (COP) of the pressure frame. At the COP, the pressure above the COP is equal to the pressure below the COP and the pressure to the left of the COP is equal to the pressure to the right of the COP. The COP may represent the center of the seatbelt contact patch as, typically, the COP is near the center of the seatbelt contact patch. In some embodiments, the belt orientation engine 230 may recompute the COP. For example, the belt orientation engine 230 may generate a circle around the COP of the pressure frame. The diameter of the circle may be equal to the width of the belt plus a buffer (e.g., the width of six cells). The belt orientation engine 230 may compute the COP using the cells within the circle. The newly computed COP (e.g., using the cells within the circle) may be different from the COP of the pressure frame, for example shifted in location. In recomputing the COP, the belt orientation engine 230 effectively discards pressure bias along any edge of the seatbelt contact patch. For example, if one edge of the seatbelt contact patch is thinner due to twisting or buckling of the seatbelt, the COP of the frame will be farther from the thinner edge, but the recomputed COP may be closer to the thinner edge, better representing the center of the seatbelt contact patch.

The belt orientation engine 230 uses the COP to compute the angle of the seatbelt. In some embodiments, the belt orientation engine 230 divides the frame of pressure vertically into two halfs, the upper half being above the COP and the lower half being below the COP. The belt orientation engine 230 computes a COP for the upper half of the frame, a “shoulder COP,” and a COP for the lower half of the frame, a “lap COP.” The belt orientation engine 230 constructs a line using the COP of the pressure frame, the shoulder COP, and the lap COP. The angle of the line relative to the pressure frame serves as an estimate of the orientation of the seatbelt contact patch relative to the pressure frame. The belt orientation engine 230 may determine that the seatbelt goes from the left shoulder to the right lap or from the right shoulder to the left lap of the crash test dummy.

In some embodiments, the belt orientation engine 230 computes the angle of the seatbelt by generating a mask and rotating the mask about the COP. The belt orientation engine 230 may generate a mask as a rectangle that is the width of the seatbelt. The length of the mask may be equal to or less than the length of the longest dimension of the pressure frame. For example, the length of the mask may be ⅘^{th}'s the length of the longest dimension of the pressure frame. The belt orientation engine 230 centers the mask on the COP of the pressure frame. The belt orientation engine 230 computes the average pressure of the cells within the mask. The belt orientation engine 230 may alternatively compute the load of the cells within the mask by multiplying the area of the mask by the pressure within the mask. The belt orientation engine 230 then rotates the mask about the COP and computes the average pressure or load of the cells within the rotated mask. For example, the belt orientation engine 230 may rotate the mask in one degree increments and compute the average pressure or load of the cells within the rotated mask. The belt orientation engine 230 determines that the angle at which the average pressure or load of the cells within the mask is the highest is the angle of the seatbelt. In some embodiments, the belt orientation engine 230 may compute a line perpendicular to a line at the angle of the seatbelt. The belt orientation engine 230 may shift the mask along the perpendicular line to determine if there is a position with higher average pressure or higher load that is not centered about the COP. If the belt orientation engine 230 determines that the average pressure or load of the mask is higher at a position not centered about the COP, the belt orientation engine 230 may recompute the COP to be located at the center of the mask.

In some embodiments, the seatbelt may be curved or twisted. The seatbelt may not lie in a straight line. In such cases, the belt orientation engine 230 may compute multiple angles for the seatbelt. The belt orientation engine 230 may split the pressure frame into segments. For each segment, the belt orientation engine 230 may compute the COP for the segment using any of the techniques described above. The belt orientation engine 230 may similarly compute an angle of the seatbelt for each section. For example, the belt orientation engine 230 may split the pressure frame horizontally to form four segments that stack ontop of one another. For each of the four segments, the belt orientation engine 230 may compute a COP of the segment and the angle of the seatbelt in that segment.

The belt centerline engine 240 computes the centerline of the seatbelt using the computed angle of the seatbelt and the computed COP. In some embodiments, such as when the seatbelt twists or curves, the belt centerline engine 240 computes a centerline corresponding to each segment of the seatbelt. To compute a centerline, the belt centerline engine 240 projects a line from the COP to the edges of the pressure frame, with the angle of the line being the computed angle. In some embodiments, the belt centerline engine 240 may adjust the angle of the centerline based on where the centerline intersects with the edges of the pressure frame. The belt centerline engine 240 may determine that, at an edge of the pressure frame, the centerline is too high or too low. For example, if centerline intersects the left edge of the pressure frame at a point that has six high pressure cells above the point and only one high pressure cell below the point, the belt centerline engine 240 may determine that the centerline is too low. The belt centerline engine 240 may adjust the centerline by either shifting the entire centerline up or by rotating the centerline.

### Example Seatbelt Centerline Determination Process

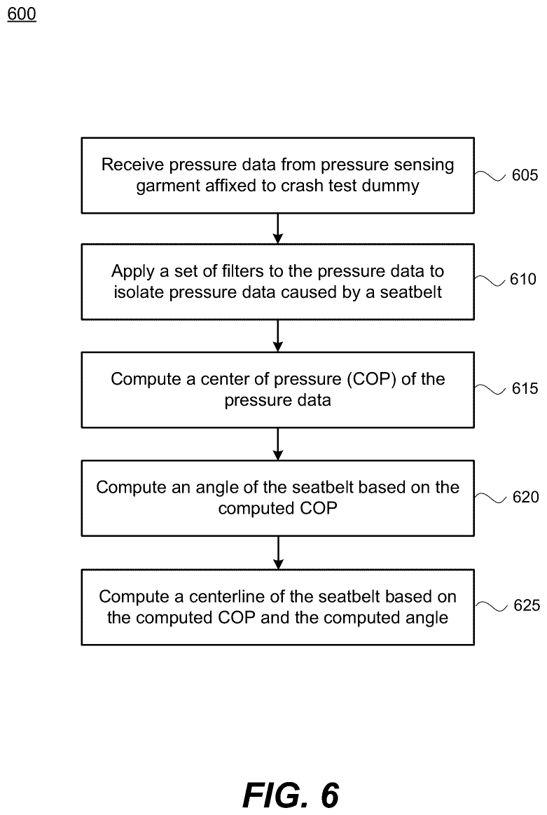

FIG. 6 is a flowchart depicting an example process for determining the centerline of a seatbelt, in accordance with some embodiments. A computer, which may be the computing server 160, may perform the process 600. Other entities may perform some or all of the steps in FIG. 6 in other embodiments. Embodiments may include different and/or additional steps or perform the steps in different orders.

The computing server 160 receives 605 pressure data from the pressure sensing garment 110 affixed to the crash test dummy 120, as described with respect to the sensor mapping engine 210. The computing server 160 may organize the pressure data into a grid of measurements representative of the sensor array, a pressure frame. In some embodiments, the computing server receives parameters associated with the sensor frame, such as the time of the pressure frame, the distance between measurements in the pressure frame, the width of the seatbelt, or other information about the crash test.

The computing server 160 applies 610 a set of filters to isolate pressure data caused by the seatbelt 140, as described with respect to the filtering engine 220. In some embodiments, the computing server 160 applies a low pressure filter to remove pressure data that is not caused by the seatbelt itself. In some embodiments, the computing server 160 may apply a filter to remove areas of pressure that are disconnected from the seatbelt contact patch. In some embodiments, the computing server 160 may apply a filter to fill in holes of the seatbelt contact patch.

The computing server 160 computes 615 a center of pressure (COP) of the pressure data, as described with respect to the belt orientation engine 230. At the COP, the pressure above the COP is equal to the pressure below the COP and the pressure to the left of the COP is equal to the pressure to the right of the COP. The COP may represent the center of the seatbelt contact patch as, typically, the COP is near the center of the seatbelt contact patch. In some embodiments, the computing server 160 may recompute the COP. For example, the computing server 160 may generate a circle around the COP of the pressure frame and compute the COP using the cells within the circle.

The computing server 160 computes 620 an angle of the seatbelt based on the computed COP, as described with respect to the belt orientation engine 230. In some embodiments, the computing server 160 divides the frame of pressure vertically into two halfs, the upper half being above the COP and the lower half being below the COP. The belt computing server 160 computes a COP for the upper half of the frame, a “shoulder COP,” and a COP for the lower half of the frame, a “lap COP.” The computing server 160 constructs a line using the COP of the pressure frame, the shoulder COP, and the lap COP. The angle of the line relative to the pressure frame serves as an estimate of the orientation of the seatbelt contact patch relative to the pressure frame. In some embodiments, the computing server 160 computes the angle of the seatbelt by generating a mask the width of the seatbelt and rotating the mask about the COP, computing the average pressure or load within the mask at each rotation. The belt computing server 160 may determine that the angle at which the average pressure or load of the cells within the mask is the highest is the angle of the seatbelt.

The computing server 160 computes 625 a centerline of the seatbelt based on the computed COP and computed angle, as described with respect to the belt centerline engine 240. The computing server 160 projects a line from the COP to the edges of the pressure frame, with the angle of the line being the computed angle. In some embodiments, the computing server 160 may adjust the angle of the centerline based on where the centerline intersects with the edges of the pressure frame.

### Example Architecture of Machine Learning Models

In various embodiments, a wide variety of machine learning techniques may be used for detection of the seatbelt position from pressure data collected by a pressure sensing garment. The machine learning techniques include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN) and recurrent neural networks (RNN) (e.g., long short-term memory networks (LSTM)), may also be used. For example, machine learning techniques may be used for filtering noise from a pressure frame, for filling holes in the seatbelt contact patch of a pressure frame, for determining an angle of the seatbelt or a centerline of the seatbelt.

In various embodiments, the training techniques for a machine learning model may be supervised, semi-supervised, or unsupervised. In supervised learning, the machine learning models may be iteratively trained with a set of training samples that are labeled. For example, for a machine learning model trained to identify a seatbelt contact patch from a pressure frame, the training samples may be different pressure frames labeled with sections corresponding to the seatbelt and corresponding to noise. The labels for each training sample may be binary or multi-class. For training a binary machine learning model (e.g., a model that identifies whether a seatbelt is in the pressure frame), training samples may include a positive training set (with training samples that have the label of having a seatbelt in the pressure frame) and a negative training set (with training samples that have the label of not having a seatbelt in the pressure frame). In some cases, an unsupervised learning technique may be used. The samples used in training are not labeled. Various unsupervised learning techniques such as clustering may be used. In some cases, the training may be semi-supervised with the training set having a mix of labeled samples and unlabeled samples.

A machine learning model may be associated with an objective function, which generates a metric value that describes the objective goal of the training process. For example, the training may intend to reduce the error rate of the model in generating predictions. In such a case, the objective function may monitor the error rate of the machine learning model. In object recognition (e.g., object detection and classification), the objective function of the machine learning algorithm may be the training error rate in classifying objects in a training set. Such an objective function may be called a loss function. Other forms of objective functions may also be used, particularly for unsupervised learning models whose error rates are not easily determined due to the lack of labels. In seatbelt contact patch detection, the objective function may correspond to the difference between the model's prediction of the position of a seatbelt contact patch and a manually identified position of a seatbelt contact patch in a pressure frame. In various embodiments, the error rate may be measured as cross-entropy loss, L1 loss (e.g., the sum of absolute differences between the predicted values and the actual value), L2 loss (e.g., the sum of squared distances).

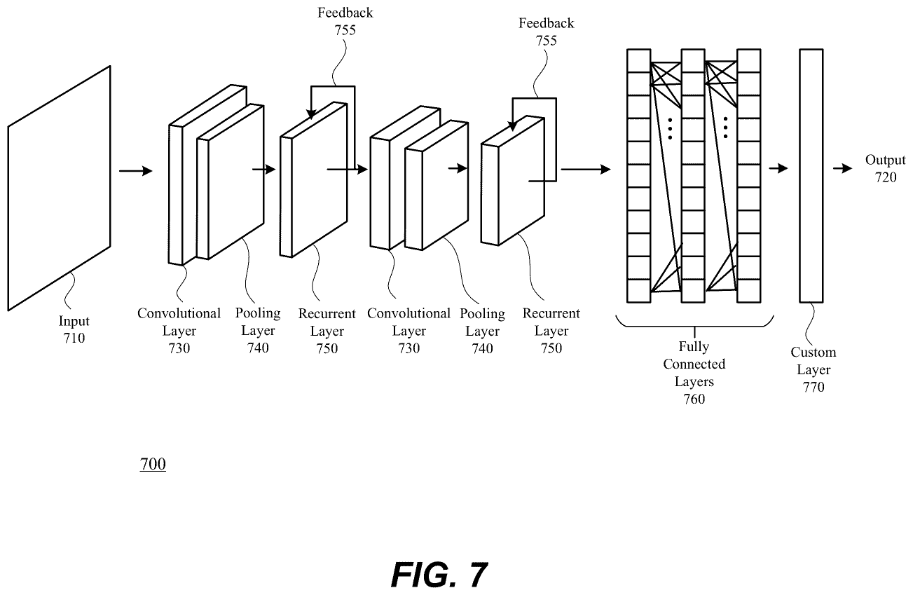

FIG. 7 shows an example structure of a neural network, which may include layers that may present in various machine learning models. For example, a CNN may include the convolutional layers and the pooling layers shown in FIG. 7. An LSTM may include the recurrent layers shown in FIG. 7. Each machine learning models may have its own structure and layers (while omitting some layers in FIG. 7). The order of the layers in FIG. 7 is also an example. The order of layers may change, depending on the type of machine learning model used.

Referring to FIG. 7, a structure of an example neural network (NN) is illustrated, according to an embodiment. The NN 700 may receive an input 710 and generate an output 720. The NN 700 may include different kinds of layers, such as convolutional layers 1230, pooling layers 740, recurrent layers 750, full connected layers 760, and custom layers 770. A convolutional layer 1230 convolves the input of the layer (e.g., an image) with one or more kernels to generate different types of images that are filtered by the kernels to generate feature maps. Each convolution result may be associated with an activation function. A convolutional layer 1230 may be followed by a pooling layer 740 that selects the maximum value (max pooling) or average value (average pooling) from the portion of the input covered by the kernel size. The pooling layer 740 reduces the spatial size of the extracted features. In some embodiments, a pair of convolutional layer 1230 and pooling layer 740 may be followed by a recurrent layer 750 that includes one or more feedback loop 755. The feedback 755 may be used to account for spatial relationships of the features in an image or temporal relationships of the objects in the image. The layers 1230, 740, and 750 may be followed in multiple fully connected layers 760 that have nodes (represented by squares in FIG. 7) connected to each other. The fully connected layers 760 may be used for classification and object detection. In one embodiment, one or more custom layers 770 may also be presented for the generation of a specific format of output 720. For example, a custom layer may be used for image segmentation for labeling pixels of an image input with different segment labels.

The order of layers and the number of layers of the NN 700 in FIG. 7 is for example only. In various embodiments, a NN 700 includes one or more convolutional layers 1230 but may or may not include any pooling layer 740, recurrent layer 750, or fully connected layers 760. If a pooling layer 740 is present, not all convolutional layers 1230 are always followed by a pooling layer 740. A recurrent layer may also be positioned differently at other locations of the CNN. For each convolutional layer 1230, the sizes of kernels (e.g., 3×3, 5×5, 7×7, etc.) and the numbers of kernels allowed to be learned may be different from other convolutional layers 1230.

A machine learning model may include certain layers, nodes, kernels and/or coefficients. Training of a neural network, such as the NN 700, may include forward propagation and backpropagation. Each layer in a neural network may include one or more nodes, which may be fully or partially connected to other nodes in adjacent layers. In forward propagation, the neural network performs the computation in the forward direction based on outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Each of the functions in the neural network may be associated with different coefficients (e.g. weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other images in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing a seatbelt contact patch detection or another suitable task for which the model is trained.

### Computing Machine Architecture

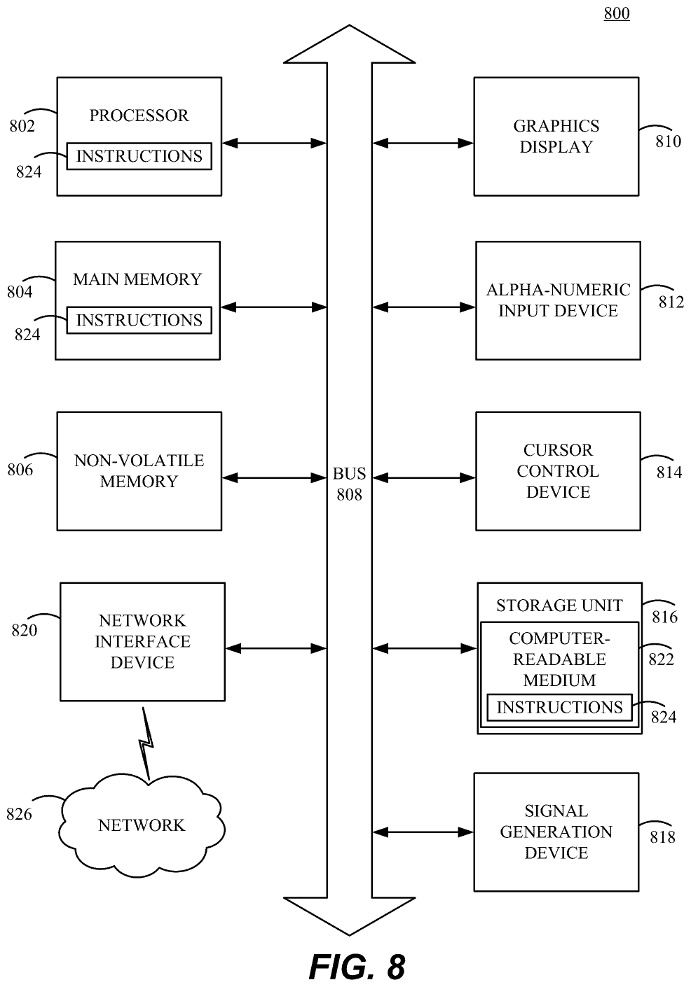

FIG. 8 is a block diagram illustrating components of an example computing machine that is capable of reading instructions from a computer-readable medium and executing them in a processor (or controller). A computer described herein may include a single computing machine shown in FIG. 8, a virtual machine, a distributed computing system that includes multiples nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a network deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIG. 1, including but not limited to, the computing server 160, the data store 170, the cloud actionable insight system 185, and any computer that performs processes such as processes 600 and 800.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors (generally, processor 802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a non-volatile memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium 822 may include any medium that is capable of storing instructions (e.g., instructions 824) for execution by the machine and that cause the machine to perform any one or more of the methodologies disclosed herein. The computer-readable medium 822 may include, but not be limited to, data repositories in the form of solid-state memories, optical media, and magnetic media. The computer-readable medium 822 does not include a transitory medium such as a signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system for determining pressure sensing data exerted on a crash test dummy during a crash test, the system comprising:
in an environment where a vehicle is configured to be pulled into a collision with the crash test dummy strapped by a seatbelt across a chest of the crash test dummy:
the pressure sensing garment configured to measure pressure applied to a chest of the crash test dummy during a collision, wherein the crash test dummy is affixed to the pressure sensing garment and the seatbelt is positioned on top of the pressure sensing garment, the pressure sensing garment comprising:
a sensor grid including a plurality of sensors configured to measure pressure data, wherein the crash test dummy is configured such that the sensor grid is positioned to the chest of the crash test dummy; and
a computer configured to:
receive pressure data from the pressure sensing garment, and
determine the position of the seatbelt based on the received pressure data.

2. The system of claim 1, wherein the pressure sensing garment is further configured to measure acceleration of the crash test dummy during the collision.

3. The system of claim 1, wherein the pressure sensing garment is further configured to measure pressure applied to a back of the crash test dummy during the collision.

4. The system of claim 1, wherein the pressure sensing garment is a flexible panel applied to the chest of the crash test dummy.

5. The system of claim 1, wherein the pressure sensing garment is a vest.

6. The system of claim 1, wherein the pressure sensing garment is a shirt.

7. The system of claim 1, wherein the computer is further configured to apply a set of filters to the pressure data to isolate pressure data caused by the seatbelt.

8. The system of claim 7, wherein the set of filters includes a low pressure filter.

9. The system of claim 1, wherein the computer is configured to compute a center of pressure (COP) of the pressure data.

10. The system of claim 9, wherein the computer is configured to compute an angle of the seatbelt based on the COP of the pressure data.

11. The system of claim 10, wherein the computer is configured to compute a centerline of the seatbelt based on the COP of the pressure data and the angle of the seatbelt.

12. The system of claim 11, wherein the computer is configured to compute the centerline of the seatbelt using a convolution neural network (CNN).

13. A method of determining a centerline of a seatbelt using a pressure sensing garment, the method comprising:
receiving pressure data from a pressure sensing garment affixed to a crash test dummy, wherein:
the pressure sensing garment is configured to measure pressure applied to a chest of the crash test dummy during a collision,
the pressure sensing garment comprises a sensor grid including a plurality of sensors configured to measure pressure data, and
the crash test dummy is strapped, by a seatbelt, into a vehicle configured to be pulled into a collision;
applying a set of filters to the pressure data to isolate pressure data caused by the seatbelt;
computing a center of pressure (COP) of the filtered pressure data;
computing an angle of the seatbelt based on the COP; and
computing a centerline of the seatbelt based on the COP and angle of the seatbelt.

14. The method of claim 13, wherein the pressure sensing garment is further configured to measure acceleration of the crash test dummy during the collision.

15. The method of claim 13, wherein the pressure sensing garment is further configured to measure pressure applied to a back of the crash test dummy during the collision.

16. The method of claim 13, wherein the pressure sensing garment is a flexible panel applied to the chest of the crash test dummy.

17. The method of claim 13, wherein the pressure sensing garment is a vest.

18. The method of claim 13, wherein the pressure sensing garment is a shirt.

19. The method of claim 13, wherein computing a centerline of the seatbelt comprises computing the centerline of the seatbelt using a convolution neural network (CNN).

20. The method of claim 13, wherein applying a set of filters to the pressure data to isolate pressure data caused by the seatbelt comprises applying a low pressure filter to the pressure data.
